(19) United States
(12) Patent Application Publication
(10) Pub. No.: US 2007/0245979 A1
(43) Pub. Date: Oct. 25, 2007

(54) Dog collar

(76) Inventors: Ilusion Morena Millan, Inglewood, CA (US); Cesar F. Millan, Inglewood, CA (US)

Correspondence Address: MARC E. HANKIN, ESQ., 11414 THURSTON CIRCLE, LOS ANGELES, CA, 90049, US

(21) Appl. No.: 11/408,379

(22) Filed: Apr. 21, 2006

(51) Int. Cl. A01K 27/00

(52) U.S. Cl. 119/864

(57) ABSTRACT

The present invention is directed to a dog collar that is comprised of at least three collars, where at least one of the collars is a slip collar, and a plurality of perpendicular elements running perpendicular to the collars, which are also connected and link to the collars.

### FIELD OF INVENTION

This invention relates generally to the field of dog collars.

### BACKGROUND

Dog owners find themselves faced with pet restraint issues, including a frequent need to restrain and maintain physical control of the pet during training, dog walking and other activities. Dogs are commonly restrained by way of attaching a leash to a flat collar, choke chain, slip, limited slip, or prong type collar that encircles the animal's neck. While these collars are currently widely used for restraining pets, they have not proven to be entirely satisfactory. These devices typically result in pressure on the animal's neck and airway, and cause choking, or pinching when the animal is attached to a leash.

Various improvements on the collar have been disclosed to address some of these limitations. For example, U.S. Pat. No. 5,690,059 discloses a leash apparatus having an elongated body with an actuator rod. A handle is fitted on one end and a strap on the other. The strap forms an adjustable noose to secure an animal. The device assists those of diminished physical capability to secure the strap about the animal's head.

U.S. Pat. No. 5,690,059 to Woods discloses a slip-type apparatus that has two collars and perpendicular elements connected to them, where at least one of the collars acts as a slip collar. However, because at least one of the collars is used as a slip collar, the entire apparatus does not remain stably secure to the dog's neck when force is applied with a leash. Moreover, because only standard shank holes spaced one inch apart are present on the collar, only one inch increments can be made, which results in a less than ideal fit for the dog.

In light of the foregoing, a need still exists for a collar that allows a dog owner to control his/her pet during training, walking, and other activities while maintaining maximum comfort for the pet.

### SUMMARY OF THE INVENTION

This invention is directed towards overcoming the above shortcomings by disclosing an apparatus that applies constant pressure around the neck of the animal for restraint, but is yet comfortable and simple to put on, and take off.

In one embodiment, the apparatus in accord with the invention is comprised of at least three collars, wherein at least one of said collars is a slip collar, with a plurality of perpendicular elements, running perpendicular to said collars, which are connected and link to said collars.

In another embodiment, the apparatus in accord with the invention is comprised of perpendicular elements connected together by a resilient fabric. Alternatively, the perpendicular elements are connected together by mesh netting.

In yet another embodiment, the apparatus in accord with the invention is comprised of at least three collars, wherein at least one of said collars is a slip collar, with more than three perpendicular elements, running perpendicular to said collars, which are connected and linked to said collars, wherein at least one of said perpendicular elements is adjustably connected to said collars, wherein at least one of said collars is made of core-wound cord, wherein the other collars are not made of core-wound cord, each having a snap-on buckle.

In a further construction, the apparatus in accord with the invention is comprised of at least three collars, wherein at least one of said collars is a slip collar, with three perpendicular elements, running perpendicular to said collars, which are connected and link to said collars, wherein two of the three perpendicular elements is adjustably connected to said collars, wherein at least one of the three collars is made of core-wound cord, and wherein the other two collars are not made of core-wound cord, each having a snap-on buckle.

An advantage of the present invention is that the apparatus is able to support the use of a slip collar around the neck of the dog without harming the dog.

A further advantage of the present invention is that the slip collar is held in the ideal position by the non-slip collars for maximum control of the dog.

An advantage of the present invention is that the buckles on the collars provide greater accuracy of fit of these collars on the dog by allowing much greater adjustments for sizing fit.

The foregoing, and other features and advantages of the invention, will be apparent from the following, more particular description of the preferred embodiments of the invention, the accompanying drawings, and the claims.

### BRIEF DESCRIPTION OF THE DRAWINGS

FIG. 1 is a side view of the collar.

FIG. 2 is a perspective view of the collar around the neck of the animal.

### DRAWINGS—REFERENCE NUMERALS

10 One embodiment of the invention
11 First non-slip collar
12 Second non-slip collar
13 Slip collar
14 First perpendicular element
15 Second perpendicular element
16 Third perpendicular element
17 Adjustable element
18 Adjustable element
19 First connector element
20 Second connector element
21 O-ring
22 O-ring
23 Keeper
24 Keeper
26 Distal end of perpendicular 14
27 Distal end of perpendicular 16
28 Proximate end of perpendicular 14
29 Proximate end of perpendicular 16
30 Distal end of perpendicular 15
31 Proximate end of perpendicular 15
32 Looped element
33 Looped element
34 Looped element
35 Looped element
Affixed element
Affixed element

### DETAILED DESCRIPTION OF THE DRAWINGS

In the following detailed description of various embodiments of the invention, numerous specific details are set forth in order to provide a thorough understanding of various aspects of one or more embodiments of the invention, however, one or more embodiments of the invention may be practiced without these specific details. In other instances, well-known methods, procedures, and/or components have not been described in detail so as not to unnecessarily obscure aspects of the embodiments of the invention.

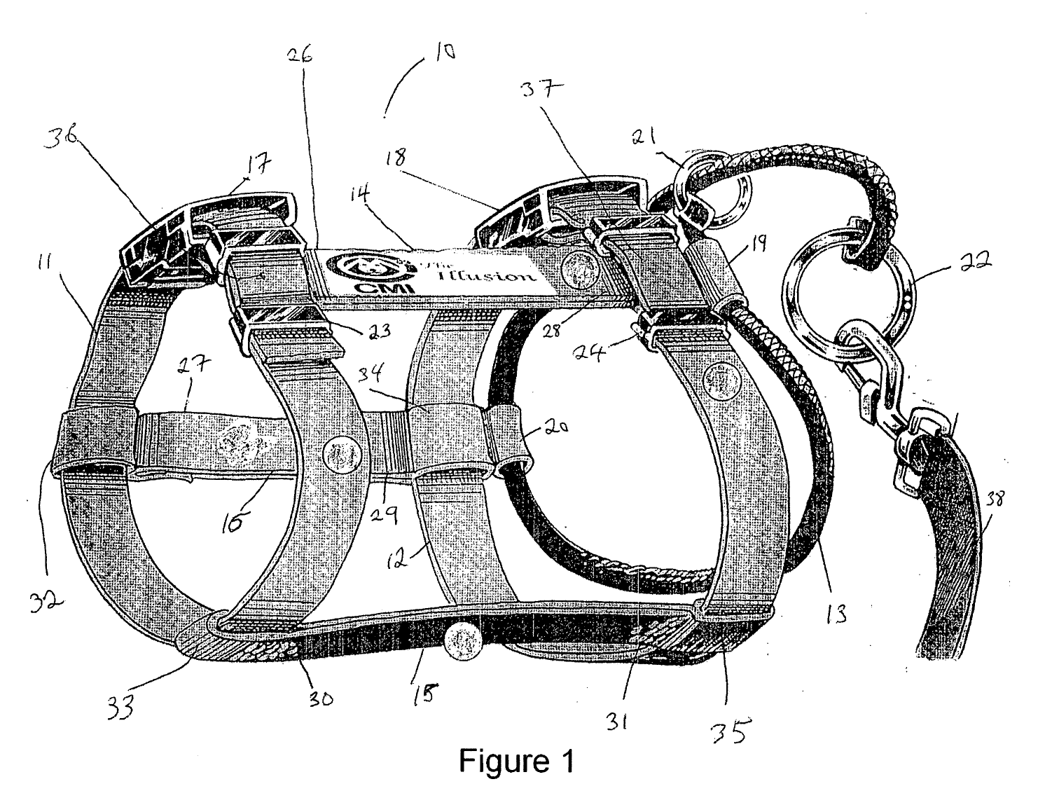

Turning now to the figures in which one presently preferred embodiment of the invention appears, FIG. 1 shows a side view of the collar 10. The invention as described is able to maintain a constant yet comfortable pressure specifically against the neck of the dog.

FIG. 1 shows that the invention can have six components that together form a web-like structure, comprising of a first flat collar 11, a second flat collar 12, and a third, rounded slip collar 13. The first 11 and second 12 collars (hereinafter are referred to as “non-slip collars”) are connected together via perpendicular elements 14, 15 and i6 that run perpendicular to the collars 11, 12 and 13. The distal end of perpendicular element 14 is permanently secured to non-slip collars 11 and 12 at its distal 26, and proximate 28 ends. In contrast, the distal (30 and 27) and proximal (31 and 29) ends of perpendicular 15 and 16 are adjustably connected to non-slip collars 11 and 12. Thus, perpendicular elements 15 and 16 can later be adjusted by the pet owner to comfortably fit the pet. Although this embodiment shows perpendicular elements 15 and 16 adjustably connected, and perpendicular element 14 permanently secured to the collars, it is understood that in alternative embodiments either the distal, and/or proximal ends of the any of the perpendicular elements, or any combinations thereof could be permanently or adjustably connected. Methods to permanently secure, or to adjustably connect these perpendicular elements to the collars are well known to those of ordinary skill in the art at this time. In this embodiment stitching at positions 36 and 37 is used to permanently secure these elements to non-slip collars 11 and 12, while looped elements 32, 33, 34 and 35 allow perpendicular elements 15 and 16 to be adjusted on non-slip collars 11 and 12, respectively.

It should be understood that although the web-like structure as shown in this embodiment is comprised of three separate and individual perpendicular elements, in an alternative embodiment there could be more than three perpendicular elements, or actual fabric or meshing connecting each perpendicular element to each other. Moreover, there could be more than three collars used but at least one of these collars should act as a slip collar 13. An unexpected benefit of adopting at least two non-slip collars is that the slip collar is held in position at the top of the neck and just behind the ears of the dog by the additional non-slip collars. Dogs respond best to corrective control when the slip collar is held in this position, because the slip collar is not allowed to travel down the dog's neck, where the trainer has less control due to the dog's musculature.

At the proximate end of perpendicular 14 and 16 is found first 19 and second connector 20 elements, enclosing slip collar 13. Slip collar 13 has also two metal rings 21 and 22 attached to each end of the slip collar 13. Ring 22 is shown here as an “O” ring having a diameter of 1 inch, whereas ring 21 is shown here as an “O” ring with a diameter of about ¾ inch. It should be appreciated that “D” rings could be used instead of the “O” rings as shown and described, and that different sizes could be used.

The combination of connector elements 19 and 20, with the two “O” rings 21 and 22, allow slip collar 13 to immediately be tightened, or loosened, when the end of the collar is pulled or released, respectively, with the leash. Slip collar 13 represents the only collar in this embodiment that can perform in this manner. There is no mechanism to define a maximum extent to which the slip collar 13 can be tightened; nor is there a mechanism to restrict the maximum loosening of slip collar 13 around the dog's neck.

Non-slip collar 12 will rest on the pet's neck just behind slip collar 13 and has an adjustable element, which in this embodiment is a conventional snap-on buckle 18 that is used to adjust and fix the diameter of non-slip collar 12. Non-slip collar 11 will sit at the base of the neck of the pet, and has an adjustable element, which in this embodiment is a conventional snap-on buckle 17 used to adjust and fix the diameter of non-slip collar 11. Slip collar 13 hangs loosely around the neck of the animal above non-slip collar 12, but below the ears of the dog.

Non-slip collars 11, 12 and 13, and all perpendicular elements 14, 15 and 16, as herein described can be made of, but not limited to, nylon, rope, leather, fabric, and core-wound cord. In the preferred embodiment, non-slip collars 11 and 12 are made of nylon, and slip collar 13 is made of core-wound cord. Adjustable elements 17 and 18 can be made of durable plastic, or metal. It should be appreciated that, although the connector elements 19 and 20 as shown can be made from the same material as the perpendicular elements, it is also possible that the loops can instead be made of a different material such as rope, metal, plastic or fabric which is appropriately connected to the perpendicular element using methods well known in the art.

Description of Operation:

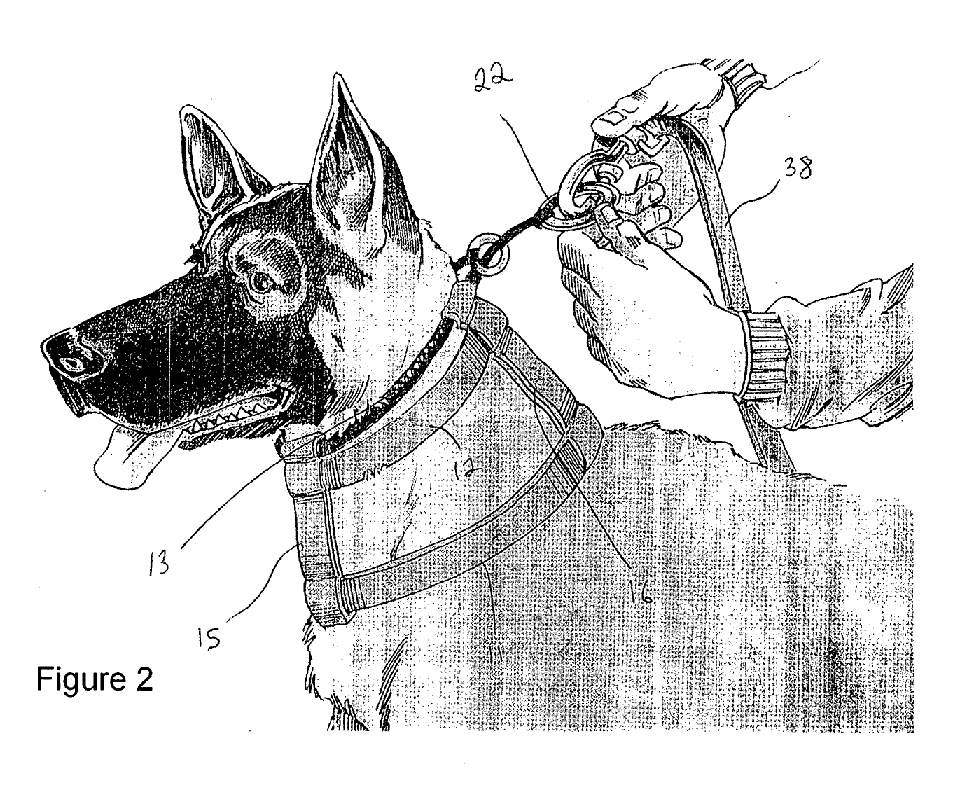

In this embodiment, to put the collar on the animal, the buckles 17 and 18 are first open by pulling up on the snap-on buckle element. Then non-slip collar 11 can be placed over the head of the animal. Non-slip collar 11 is then tightened by threading its strap through the buckle 17. The perimeter of non-slip collar 11 is then fixed by pressing down firmly until a “snap” is heard, signifying that the buckle is fully closed. The process is repeated for non-slip collar 12, which will rest on the base of the animal's neck. FIG. 2 shows that both non-slip collars 11 and 12 should fit snugly, but not tightly, and they hold slip collar 13 in position for control. Once non-slip collars 11 and 12 are fastened, the ends are slid through the keepers 23 and 24. Perpendicular element 16 is movable and should be adjusted so that it rests on the top of the neck of the animal. Perpendicular element 15 is also movable and should be adjusted so that it centers at the throat of the animal. Perpendicular element 14, in this embodiment, is permanently stitched into place.

Finally, a leash 38 is attached to “O” ring 22 on slip collar 13. Pulling the leash will allow slip collar 13 to be tightened or loosened, thereby achieving control over the animal.

It should be understood that the invention has application far beyond the exemplary embodiments presented and described herein, and as such, is not to be limited strictly to those embodiments. In addition, the invention is not limited to the particular physical configuration, but instead is adaptable. All changes, modifications, variations, and other uses and applications which do not depart from the spirit and scope of the invention are deemed to be covered by the invention.

What is claimed is:

1. An apparatus for training animals comprising:
(a) at least three collars, wherein at least one of said collars is a slip collar, and
(b) a plurality of perpendicular elements, running perpendicular to said collars, which are connected and link to said collars.

2. The apparatus of claim 1, wherein said perpendicular elements are connected together by a resilient fabric.

3. The apparatus of claim 1, wherein said perpendicular elements are connected together by a mesh net.

4. The apparatus of claim 1, wherein there are more than three said perpendicular elements.

5. The apparatus of claim 4, wherein there are more than three said collars.

6. The apparatus of claim 1, wherein there are three said collars.

7. The apparatus of claim 6, wherein there are three said perpendicular elements.

8. The apparatus of claim 7, wherein at least one of the three perpendicular elements is adjustably connected to said collars.

9. The apparatus of claim 7, wherein two of said perpendicular elements are adjustably connected to said collars.

10. The apparatus of claim 1, wherein the collars and perpendicular elements are made of material selected from the group consisting of nylon, rope, leather, fabric, and core-wound cord.

11. The apparatus of claim 9, wherein at least one collar is made of core-wound cord.

12. The apparatus of claim 11, wherein two of the said collars have an adjustable element.

13. The apparatus of claim 12, wherein said adjustable element is a snap-on buckle.

14. An apparatus for training animals comprising:
(a) at least three collars, wherein at least one of said collars is a slip collar, and
(b) a plurality of perpendicular elements, running perpendicular to said collars, which are connected and link to said collars,
wherein at least one of the perpendicular elements is adjustably connected to said collars,
wherein at least one of the collars is made of core-wound cord, and
wherein the other collars, not made of core-wound cord, have a snap-on buckle.

15. An apparatus for training animals comprising:
(a) at least three collars, wherein at least one of said collars is a slip collar, and
(b) a plurality of perpendicular elements, running perpendicular to said collars, which are connected and link to said collars,
wherein there are three collars,
wherein there are three perpendicular elements,
wherein two of the three perpendicular elements is adjustably connected to said collars,
wherein one of the three collars is made of core-wound cord, and
wherein the other two collars, not made of core-wound cord, each have a snap-on buckle.
